(19) United States
(12) Patent Application Publication
(10) Pub. No.: US 2024/0381210 A1
(43) Pub. Date: Nov. 14, 2024

(54) Method And Apparatus For Radio Link Problem Prediction And Early Recovery In Mobile Communications

(71) Applicant: MediaTek Singapore Pte. Ltd., Singapore (SG)

(72) Inventors: Hongwei Zhang, Beijing (CN); Yan Wu, Beijing (CN); Yongtuan Qiao, Beijing (CN); Xin Li, Beijing (CN); Guangpu Wang, Beijing (CN)

(21) Appl. No.: 18/655,371

(22) Filed: May 6, 2024

(30) Foreign Application Priority Data
May 12, 2023 (CN) 202310538088.1
Apr. 28, 2024 (CN) 202410523843.3

(51) Int. Cl. H04W 36/30; H04W 36/00; H04W 76/19

(52) U.S. Cl. CPC H04W 36/304; H04W 36/0058; H04W 76/19

(57) ABSTRACT

Various solutions for radio link (RL) problem prediction with respect to user equipment and network node in mobile communications are described. An apparatus may perform an RL problem prediction according to an apparatus context to generate a prediction result before a radio link failure (RLF) occurs. The apparatus may determine whether to perform RL early recovery based on the prediction result.

### CROSS REFERENCE TO RELATED PATENT APPLICATION(S)

The present disclosure is part of a non-provisional application claiming the priority benefit of China Application No. 202310538088.1, filed 12 May 2023, and China Application No 202410523843.3, filed 28 Apr. 2024. The contents of aforementioned applications are herein incorporated by reference in their entirety.

### TECHNICAL FIELD

The present disclosure is generally related to mobile communications and, more particularly, to radio link (RL) problem prediction and early recovery with respect to user equipment (UE) and network apparatus in mobile communications.

### BACKGROUND

Unless otherwise indicated herein, approaches described in this section are not prior art to the claims listed below and are not admitted as prior art by inclusion in this section.

In mobile communications, when a radio link failure (RLF) occurs, an RLF recovery procedure between the UE and the network node will be performed. However, in the traditional RLF recovery procedure, when the reestablishment procedure is performed for the RLF, the radio link problem may have occurred over a long period of time, i.e., the radio link problem cannot be recovered in a short period of time. Therefore, the service may be interrupted over a long period of time before the reestablishment is performed for the RLF.

For example, for downlink (DL) RLF, the reestablishment procedure will not be performed until the timer T310 has expired. Therefore, the radio link problem (e.g., out of synchronization) may have occurred over a long period of time before the timer T310 is expired. In another example, for uplink (UL) RLF, the reestablishment procedure will not be performed until a default number of times of random access (RA) attempts have been performed. Therefore, the radio link problem may have occurred over a long period of time before the maximum number of RA attempts is reached.

Accordingly, how to recover the radio link problem earlier may be an important issue for newly developed wireless communication systems. Therefore, there is a need to provide proper schemes and designs to solve this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to radio link (RL) problem prediction and early recovery with respect to user equipment and network apparatus in mobile communications. It is believed that the above-described issue would be avoided or otherwise alleviated by implementing one or more of the proposed schemes described herein.

In one aspect, a method may involve an apparatus performing a RL problem prediction according to an apparatus context to generate a prediction result before a radio link failure (RLF) occurs. The method may also involve the apparatus determining whether to perform RL early recovery based on the prediction result.

In another aspect, a method may involve a network node receiving a measurement report with a prediction result of an RL problem prediction from a UE. The method may also involve the network node determining whether to respond to the measurement report based on the prediction result.

It is noteworthy that, although description provided herein may be in the context of certain radio access technologies, networks and network topologies such as 5th Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, used to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario for a measurement procedure for RL problem prediction in accordance with implementations of the present disclosure.

FIG. 3 is a diagram depicting an example scenario for an early recover procedure under a first proposed scheme in accordance with implementations of the present disclosure.

FIG. 4 is a diagram depicting an example scenario for an early recover procedure under a second proposed scheme in accordance with implementations of the present disclosure.

FIG. 5 is a diagram depicting an example flow for an early recover procedure in accordance with implementations of the present disclosure.

FIG. 6 is a diagram depicting an example scenario for an early recover procedure under a third proposed scheme in accordance with implementations of the present disclosure.

FIG. 7 is a diagram depicting an example scenario for a prediction result in accordance with implementations of the present disclosure.

FIG. 8 is a diagram depicting another example for a prediction result in accordance with implementations of the present disclosure.

FIG. 9 is a diagram depicting another example for a prediction result in accordance with implementations of the present disclosure.

FIG. 10 is a diagram depicting an example scenario for an early recovery for DL RL problem by handover in accordance with implementations of the present disclosure.

FIG. 11 is a diagram depicting an example scenario for an early recovery for UL RL problem by handover in accordance with implementations of the present disclosure.

FIG. 12 is a diagram depicting an example scenario for an early recovery for DL RL problem by reestablishment in accordance with implementations of the present disclosure.

FIG. 13 is a diagram depicting an example scenario for an early recovery for UL RL problem by reestablishment in accordance with implementations of the present disclosure.

FIG. 14 is a block diagram of an example communication system in accordance with an implementation of the present disclosure.

FIG. 15 is a flowchart of an example process in accordance with an implementation of the present disclosure.

FIG. 16 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to radio link (RL) problem prediction and early recovery with respect to user equipment and network apparatus in mobile communications. According to the present disclosure, several possible solutions may be implemented separately or jointly. That is, although these possible solutions may be described below separately, two or more of these possible solutions may be implemented in one combination or another.

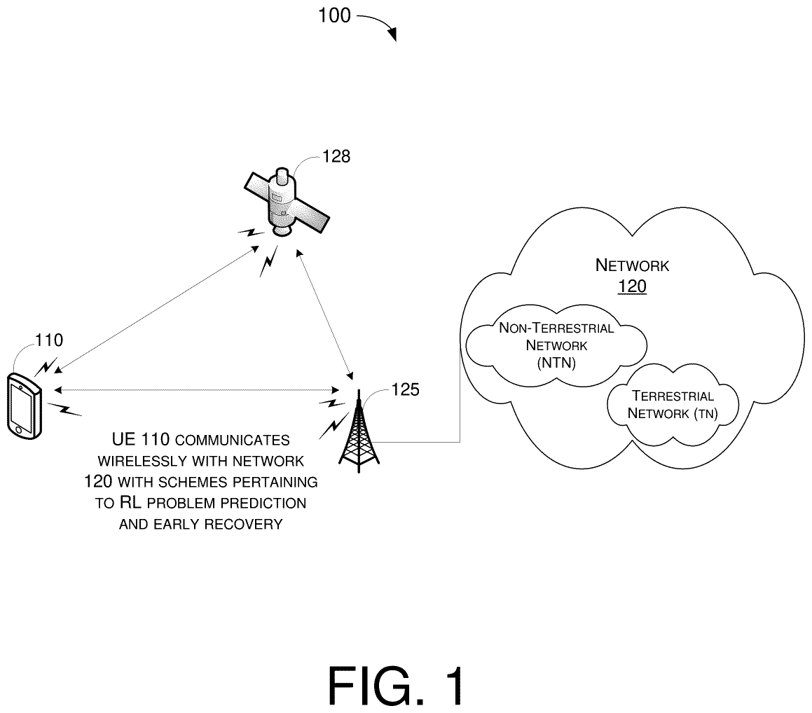

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such communication environment, the UE 110, the network 120, the terrestrial network node 125, and the non-terrestrial network node 128 may implement various schemes pertaining to RL problem prediction in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

According to the implementations of the present disclosure, a UE (e.g., the UE 110) may perform an RL problem prediction according to an apparatus context to generate a prediction result before a radio link failure (RLF) occurs. Then, the UE may transmit a measurement report with the prediction result to a network node (e.g., the terrestrial network node 125 or the non-terrestrial network node 128) of a wireless network (e.g., the network 120).

The RL problem may comprise at least one of downlink (DL) out of synchronization (sync), a radio link control (RLC) retransmission fail, and an uplink (UL) random access (RA) procedure fail. The UL RA procedure may occur during a connection setup procedure, a handover procedure, a reestablishment procedure, or other connected state RA procedures.

The UE can predict whether an RLF may occur according to the information of the historical apparatus context before the RLF occurs really. According to the implementations of the present disclosure, the apparatus context is the context information of the UE within the latest time length which may comprise at least one of cell measurement results, channel state information, power information, a control command, configured parameter information, historical camping cell information, state information of the apparatus, and a service type.

The measurement results may comprise the measurement results of the serving cell and neighbor cells, e.g., at least one of the received signal strength indication (RSSI), the reference symbol received power (RSRP), the reference symbol received quality (RSRQ), and signal to interference plus noise ratio (SINR) of the serving cell and neighbor cells.

The channel state information may comprise at least one of a channel quality indicator (CQI), a rank indication (RI), a UL block error rate (BLER) of physical (PHY) layer, a DL BLER of PHY layer, the number of retransmission of hybrid automatic repeat request (HARQ) of media access control (MAC) layer, the retransmission rate of HARQ of MAC layer, the number of retransmission of protocol data unit (PDU) of radio link control (RLC) layer and packet data convergence protocol (PDCP) layer, the retransmission rate of the PDU of RLC layer and PDCP layer, and the packet loss rate of the PDU of RLC layer and PDCP layer.

The power information may comprise the terminal transmission power information, e.g., at least one of the real time terminal transmission power, the maximum of the terminal transmission power, and the power headroom rate (PHR) information.

The control command or the configured parameter information may comprise at least one of a time advance (TA), a transmission power control (TPC) command information, a modulation and coding scheme (MCS), the scheduling of the number of multi-input multi-output (MIMO) layers, time and frequency resource allocation (e.g., the number of allocated resource blocks (RBs), the number of UL grants, etc.), cell selection and cell reselection parameters, and other information (e.g., the RSRP, RSRQ, SINR of the receiving signals in the network end, the BLER, the current serving cell loading (e.g., the number of UEs accessing the serving cell), etc.) which can be used to increase the accuracy of the prediction.

The historical camping cell information may comprise the public land mobile network (PLMN) ID, the tracking area code (TAC), the cell ID, the radio access technology (RAT), the frequency, the physical cell identity (PCI), the order, and the time period of the camping cell, and the reasons of triggering the UE to switch cell (e.g., a normal switch, reestablish to a new cell after RLF, an early handover triggered by the UE, an early reestablishment triggered by the UE, there is not enough radio resource providing for the current service, etc.).

The state information of the apparatus may comprise at least one of the speed, the temperature, the voltage, the interference from other wireless devices, and the location (indoor, outdoor, a high speed rail, a basement, a tunnel, etc.) of the UE.

The service type may comprise the service which is performing by the UE (e.g., a voice call, a streaming, an online gaming), and the required quality of service (QOS).

According to the implementations of the present disclosure, the UE may perform the RL problem prediction based on at least one of a rule-based algorithm, a machine learning (ML) algorithm, a deep learning (DL) algorithm and an artificial intelligence (AI) algorithm.

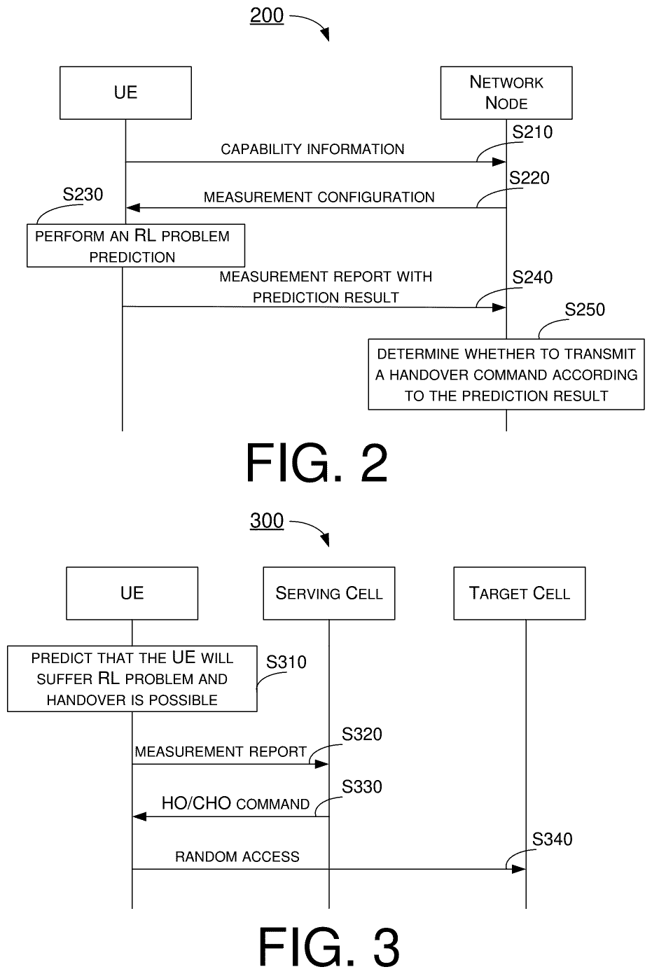

FIG. 2 illustrates an example scenario 200 for a measurement procedure for RL problem prediction in accordance with implementations of the present disclosure. Scenario 200 involves a UE and a network node (e.g., a (macro/micro) base station) of a serving cell which may be a part of a wireless network (e.g., an LTE network, a 5G/NR network, an IoT network or a 6G network). Referring to FIG. 2, in step S210, the UE may transmit capability information to the network node to indicate whether the UE supports the RL problem prediction. For example, the UE may transmit capability information to the network node through a UECapabilityInformation message. When the UECapabilityInformation comprises message a parameter support_RL_Problem_Prediction with a value being set as “True”, it may indicate that the UE can support the RL problem prediction.

In step S220, the UE may receive a measurement configuration from the network node. The measurement configuration may configure the measurement report. For example, the UE may receive the measurement configuration through an RRCReconfiguration message. When the RRCReconfiguration message comprises a parameter include_RL_Problem_Prediction_result with a value being set as “True”, it may indicate that the measurement report can include a prediction result.

In step S230, the UE may perform the RL problem prediction according to an apparatus context to generate a prediction result before an RLF occurs.

In step S240, the UE may transmit a measurement report with the prediction result to the network node.

In step S250, the network node may determine whether to transmit a handover command to the UE according to the prediction result. In an example, in an event that the prediction result indicates that the RL problem will not occur, or the possibility of RL problem is low, the network node may pend the handover command to reduce the unnecessary handover. In another example, in an event that the prediction result indicates that the RL problem will occur, or the possibility of RL problem is high, the network node may transmit a configuration with a handover command (e.g., an RRCReconfiguration with handover or conditional handover command) to the UE to initiate an early recovery procedure for avoiding the possible RLF. Then, the UE may switch to a target cell according to the handover command.

FIG. 3 illustrates an example scenario 300 for an early recover procedure under a first proposed scheme in accordance with implementations of the present disclosure. Scenario 300 involves a UE, a network node (e.g., a (macro/micro) base station) implemented as a serving cell and a network node (e.g., a (macro/micro) base station) implemented as a target cell, which may be a part of a wireless network (e.g., an LTE network, a 5G/NR network, an IoT network or a 6G network). Referring to FIG. 3, in step S310, the UE predicts that it may suffer an RL problem (i.e., the prediction result indicates that the RL problem will occur or the possibility of RL problem is high) and determines that changing serving cell by handover is possible (e.g., UE has received measurement configuration for handover, the UE is not performing handover currently, the UE has measured at least one neighboring cell that meets the predefined signal quality, etc.).

In step S320, if the serving cell supports RL problem prediction result report, the UE may transmit a measurement report with the prediction result to the serving cell, otherwise the UE may transmit a measurement report without the prediction result to the serving cell. Whether the measurement report includes the prediction result or not depends on if the network node supports the RL problem prediction result report or not (i.e., the measurement configuration may indicate whether the measurement report can include a prediction result).

In step S330, the UE may receive a handover (HO) command (or a conditional handover (CHO) command) from the serving cell (e.g., through RRCReconfiguration message).

In step S340, the UE may perform random access procedure to switch to the target cell based on the handover command to complete the early recovery for avoiding the RLF.

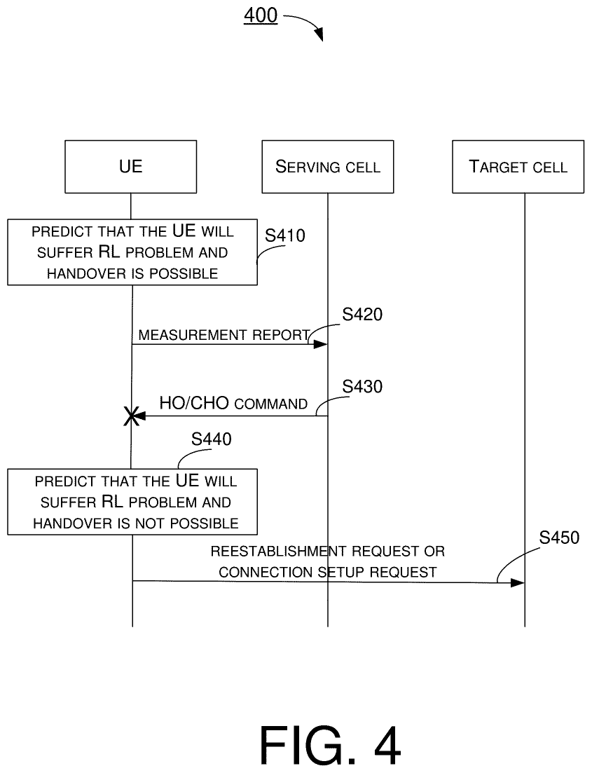

FIG. 4 illustrates an example scenario 400 for an early recover procedure under a second proposed scheme in accordance with implementations of the present disclosure. Scenario 400 involves a UE, a network node (e.g., a (macro/micro) base station) implemented as a serving cell and a network node (e.g., a (macro/micro) base station) implemented as a target cell, which may be a part of a wireless network (e.g., an LTE network, a 5G/NR network, an IoT network or a 6G network). Referring to FIG. 4, in step S410, the UE predicts that it may suffer an RL problem (i.e., the prediction result indicates that the RL problem will occur) and determines that changing serving cell by handover is possible (e.g., the UE has received measurement configuration for handover, the UE is not performing handover currently, the UE has measured at least one neighboring cell that meets the predefined signal quality, etc.)).

In step S420, the UE may transmit a measurement report to the serving cell. Whether the measurement report includes the prediction result or not depends on if the network node supports the RL problem prediction result report or not (i.e., the measurement configuration may indicate whether the measurement report can include a prediction result).

In step S430, the UE fails to receive a handover command (or a conditional handover (CHO) command) from the serving cell (e.g., RRCReconfiguration message is not received by the UE).

In step S440, the UE predicts that it may suffer an RL problem (i.e., the prediction result indicates that the RL problem will occur) and determines that changing serving cell by handover is not possible (e.g., a timer for waiting for a response (e.g., a configuration with handover command or conditional command) for the measurement report from the serving cell has expired).

In step S450, the UE may transmit a reestablishment request (e.g., RRCReestablishmentReq) or a connection setup request (e.g., RRCConnectionSetupReq) to the target cell to initiate the early recovery for avoiding long time service interruption. It should be noted that, in the second proposed scheme, the target cell may be the same as the serving cell.

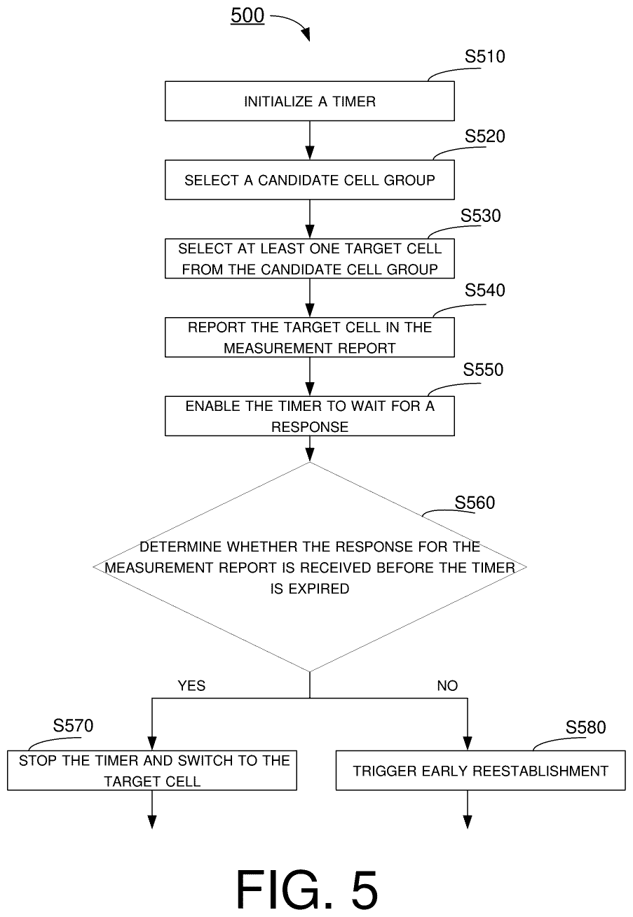

FIG. 5 illustrates an example flow 500 for an early recover procedure in accordance with implementations of the present disclosure. Scenario 500 involves a UE, a network node (e.g., a (macro/micro) base station) implemented as a serving cell and a network node (e.g., a (macro/micro) base station) implemented as a target cell, which may be a part of a wireless network (e.g., an LTE network, a 5G/NR network, an IoT network or a 6G network). In step S510, the UE may initialize a timer (e.g., a protection timer) T_{guard}.

In step S520, the UE may select a candidate cell group. Specifically, the UE may select the candidate cells from the measured neighbor cells to form the candidate cell group according to the signal strengths and/or signal qualities of the measured neighbor cells. For example, when at least one of signal condition of a neighbor cell is met (e.g., the RSRP of the neighbor cell is larger than a RSRP threshold, the RSRQ of the neighbor cell is larger than a RSRQ threshold and the SINR of the neighbor cell is larger than a SINR threshold), the UE may select the neighbor cell as a candidate cell of the candidate cell group.

In step S530, the UE may select at least one target cell from the candidate cell group. Specifically, the UE may divide the candidate cells of the candidate cell group into different sub-groups according to the frequency from measurement object (i.e., the candidate cells have the same frequency may be in the same sub-group). Then, the UE may select the candidate cell with the highest signal strength in each sub-group, and the signal strength of the selected candidate cell may be regarded as the signal strength value of its corresponding sub-group. Then, the UE may sort the sub-groups according to its signal strength values. Then, the UE may select at least one target cell from the sub-groups (e.g., according to traversal rule).

In step S540, the UE may report the selected target cell or target cells in the measurement report. That is, the measurement report may comprise the information of the selected target cell or target cells.

In step S550, the UE may enable the timer T_{guard} to wait for a response (e.g., a configuration with handover command or conditional handover command) for the measurement report from the network node.

In step S560, the UE may determine whether the response for the measurement report is received from the network node before the timer T_{guard} is expired.

In step S570, in an event that the response for the measurement report is received from the network node before the timer is expired, the UE may stop the timer T_{guard}, and then the UE may switch to the target cell according to the handover command in the response.

In step S580, in an event that the response for the measurement report is not received from the network node before the timer is expired, the UE may trigger an early reestablishment, i.e., the UE may transmit a reestablishment request or a connection setup request to the target cell.

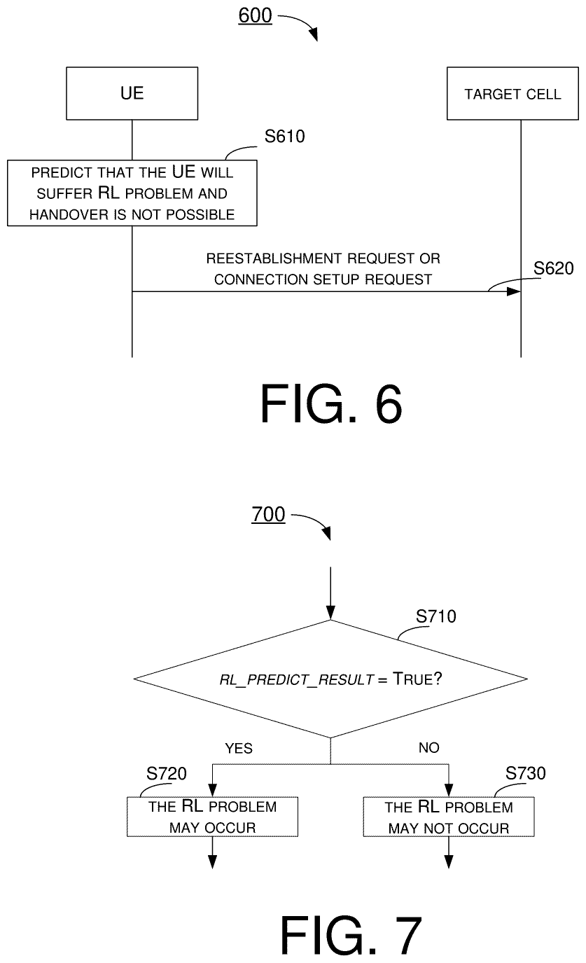

FIG. 6 illustrates an example scenario 600 for an early recover procedure under a third proposed scheme in accordance with implementations of the present disclosure. Scenario 600 involves a UE and a network node (e.g., a (macro/micro) base station) implemented as a target cell, which may be a part of a wireless network (e.g., an LTE network, a 5G/NR network, an IoT network or a 6G network). Referring to FIG. 6, in step S610, the UE predicts that it may suffer an RL problem (i.e., the prediction result indicates that the RL problem will occur or the possibility of RL problem is high) and determines that changing the serving cell by handover is not possible (e.g., In the third proposed scheme, due to that a measurement configuration for handover is not configured by the network node of the serving cell, or the UE fails to receive a handover command after transmitting a measurement report to the network node of the serving cell, or a DL BLER or an UL BLER is higher than a threshold which could result in the UE failing to receive the handover command, or none of the measured neighboring cell meets the predefined signal quality, etc.)

In step S620, the UE may transmit a reestablishment request (e.g., RRCReestablishmentReq) or a connection setup request (e.g., RRCConnectionSetupReq) to a target cell to initiate the early recovery for minimizing the service interruption prior to RLF occurrence.

According to the implementations of the present disclosure, the prediction result (e.g., a parameter rl_predict_result) may comprise at least one of a Boolean value (e.g., true/false or yes/no), one or more levels and a series of numbers.

FIG. 7 illustrates an example scenario 700 for a prediction result in accordance with implementations of the present disclosure. Referring to FIG. 7, the prediction result is expressed by the Boolean value. In an example, the prediction result may be expressed by “True” or “False”. In step S710, the UE may determine whether the prediction result is “True”. In step S720, when the prediction result is “True” (i.e., rl_predict_result=True), the prediction result may indicate that the RL problem will occur, i.e., the early recover procedure will be triggered. In step S730, when the prediction result is “False” (i.e., rl_predict_result=False), the prediction result may indicate that the RL problem will not occur, i.e., the early recover procedure will not be triggered.

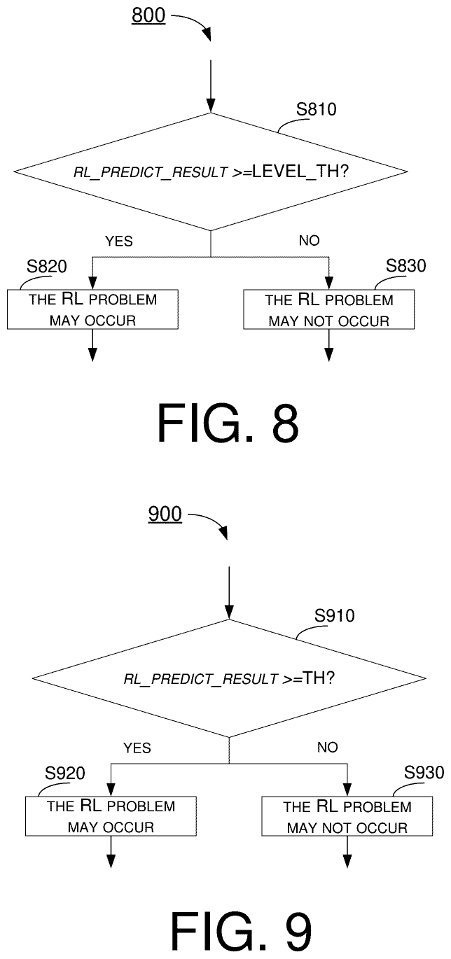

FIG. 8 illustrates another example scenario 800 for a prediction result in accordance with implementations of the present disclosure. Referring to FIG. 8, the prediction result is expressed by one or more levels (e.g., level 0, level 1 . . . level n). Higher level may correspond to higher probability of the RL problem. In step S810, the UE may determine whether the prediction result is higher than or equal to a level threshold LEVEL_TH. In step S820, when the prediction result is higher than or equal to a level threshold LEVEL_TH (i.e., rl_predict_result≥LEVEL_TH), the prediction result may indicate that the RL problem will occur, i.e., the early recover procedure will be triggered. In step S830, when the prediction result is lower than the level threshold LEVEL_TH (i.e., rl_predict_result<LEVEL_TH), the prediction result may indicate that the RL problem will not occur, i.e., the early recover procedure will not be triggered.

FIG. 9 illustrates another example scenario 900 for a prediction result in accordance with implementations of the present disclosure. Referring to FIG. 9, the prediction result is expressed by a series of numbers (e.g., 0˜1.0). The series of numbers may mean the probability of occurring the RL problem. In step S910, the UE may determine whether the prediction result is higher than or equal to a number threshold TH. In step S920, when the prediction result is higher than or equal to a number threshold TH (i.e., rl_predict_result≥TH), the prediction result may indicate that the RL problem will occur, i.e., the early recover procedure will be triggered. In step S930, when the prediction result is lower than the number threshold TH (i.e., rl_predict_result<TH), the prediction result may indicate that the RL problem will not occur, i.e., the early recover procedure will not be triggered.

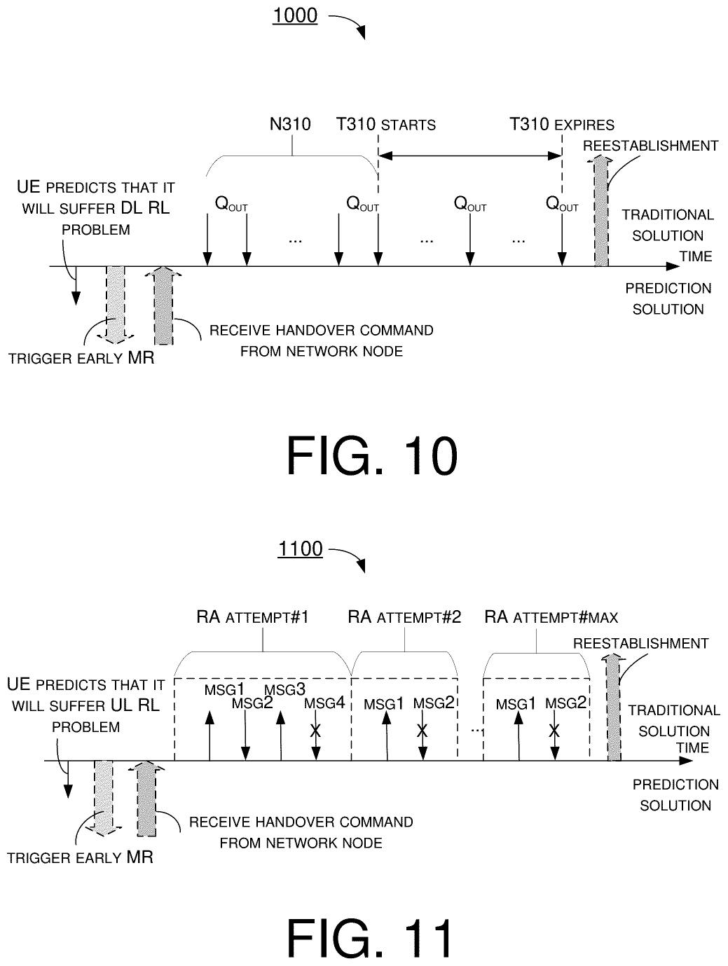

FIG. 10 illustrates an example scenario 1000 for an early recovery for DL RL problem by handover in accordance with implementations of the present disclosure. Referring to FIG. 10, when the UE predicts that it will suffer a DL RL problem, the UE may trigger an early measurement report (MR) (i.e., the UE may transmit a measurement report which may include the prediction result to the network node), and switch to a better cell (i.e., target cell) according to the handover command from the network node to avoid the RLF. Compared to traditional solution, the UE does not need to suffer out of sync problem and wait for the timer T310 to expire. The UE can switch to a better cell (i.e., target cell) before the RLF occurs. Therefore, the service interruption caused by RLF can be avoided.

FIG. 11 illustrates an example scenario 1100 for an early recovery for UL RL problem by handover in accordance with implementations of the present disclosure. Referring to FIG. 11, when the UE predicts that it will suffer an UL RL problem, the UE may trigger an early measurement report (i.e., the UE may transmit a measurement report which may include the prediction result to the network node), and switch to a better cell (i.e., target cell) according to the handover command from the network node to avoid the RLF. Compared to traditional solution, the UE does not need to suffer UL radio link interruption and wait for RA attempt number reach to the maximum value configured by network. The UE can switch to a better cell (i.e., target cell) before the RLF occurs. Therefore, the service interruption caused by the RLF can be avoided.

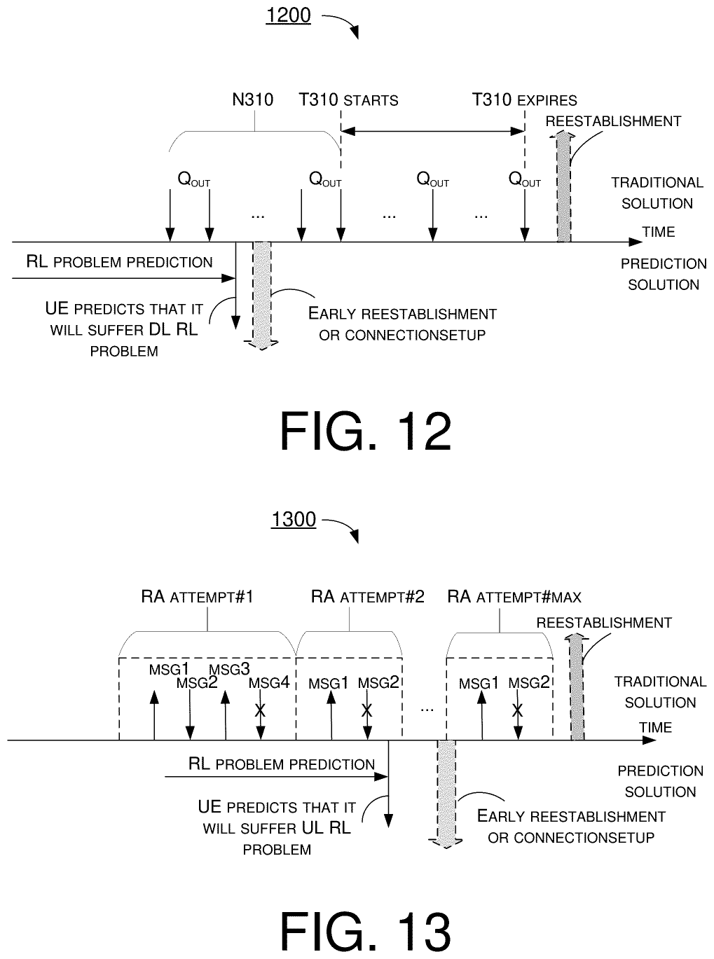

FIG. 12 illustrates an example scenario 1200 for an early recovery for DL RL problem by reestablishment procedure in accordance with implementations of the present disclosure. Referring to FIG. 12, when the UE predicts that it will suffer a DL RL problem, the UE may trigger an early reestablishment procedure (i.e., the UE may transmit a reestablishment request or a connection setup request to a target cell) to avoid long time service interruption. Comparing to traditional solution, the UE does not need to wait for the timer T310 to expire. The UE can switch to a better cell (i.e., target cell) in advance before the RLF occurs. Therefore, the service interruption prior to RLF occurrence can be minimized.

FIG. 13 illustrates an example scenario 1300 for an early recovery for UL RL problem by reestablishment procedure in accordance with implementations of the present disclosure. Referring to FIG. 13, when the UE predicts that it will suffer an UL RL problem, the UE may trigger an early reestablishment procedure (i.e., the UE may transmit a reestablishment request or a connection setup request to a target cell) to avoid long time service interruption. Comparing to traditional solution, the UE will not wait to reach the maximum number of RA attempt. The UE can switch to a better cell (i.e., target cell) in advance before the RLF occurs. Therefore, the service interruption prior to RLF occurrence can be minimized.

### Illustrative Implementations

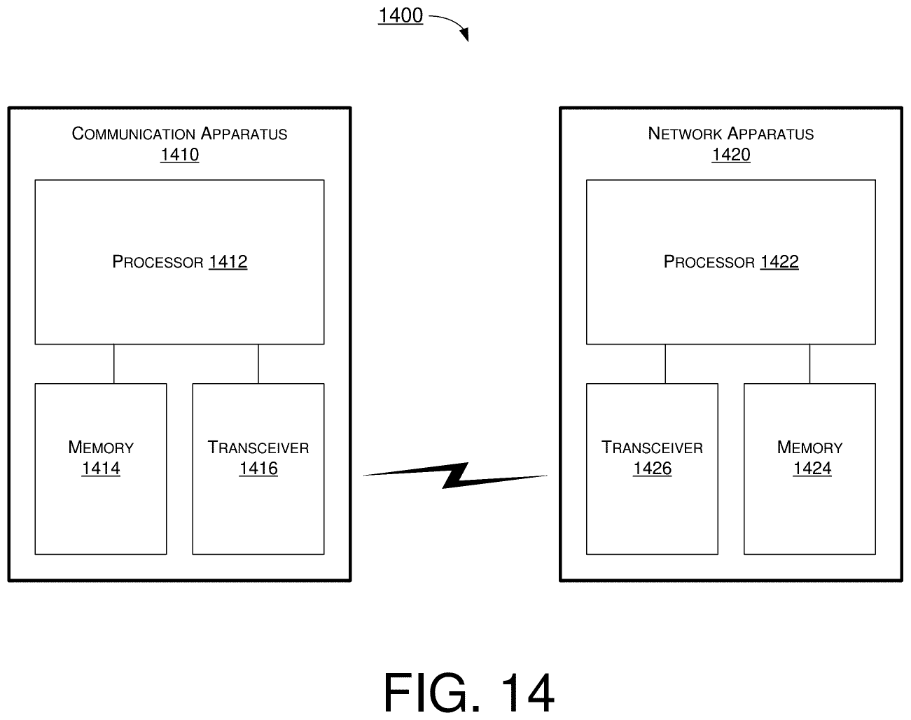

FIG. 14 illustrates an example communication system 1400 having at least an example communication apparatus 1410 and an example network apparatus 1420 in accordance with an implementation of the present disclosure. Each of communication apparatus 1410 and network apparatus 1420 may perform various functions to implement schemes, techniques, processes and methods described herein pertaining to RL problem prediction and early recovery, including the various schemes described above with respect to various proposed designs, concepts, schemes and methods described above and with respect to user equipment and network apparatus in mobile communications, including scenarios/schemes described above as well as process 1500 and process 1600 described below.

Communication apparatus 1410 may be a part of an electronic apparatus, which may be a UE such as a portable or mobile apparatus, a wearable apparatus, a wireless communication apparatus or a computing apparatus. For instance, communication apparatus 1410 may be implemented in a smartphone, a smartwatch, a personal digital assistant, a digital camera, or a computing equipment such as a tablet computer, a laptop computer or a notebook computer. Communication apparatus 1410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1410 may be implemented in a smart thermostat, a smart fridge, a smart door lock, a wireless speaker or a home control center. Alternatively, communication apparatus 1410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1410 may include at least some of those components shown in FIG. 14 such as a processor 1412, for example. Communication apparatus 1410 may further include one or more other components not pertinent to the proposed scheme of the present disclosure (e.g., internal power supply, display device and/or user interface device), and, thus, such component(s) of communication apparatus 1410 are neither shown in FIG. 14 nor described below in the interest of simplicity and brevity.

Network apparatus 1420 may be a part of a network apparatus, which may be a network node such as a satellite, a base station, a small cell, a router or a gateway. For instance, network apparatus 1420 may be implemented in an eNodeB in an LTE network, in a gNB in a 5G/NR, IoT, NB-IoT or IIoT network or in a satellite or base station in a 6G network. Alternatively, network apparatus 1420 may be implemented in the form of one or more IC chips such as, for example and without limitation, one or more single-core processors, one or more multi-core processors, or one or more RISC or CISC processors. Network apparatus 1420 may include at least some of those components shown in FIG. 14 such as a processor 1422, for example. Network apparatus 1420 may further include one or more other components not pertinent to the proposed scheme of the present disclosure (e.g., internal power supply, display device and/or user interface device), and, thus, such component(s) of network apparatus 1420 are neither shown in FIG. 14 nor described below in the interest of simplicity and brevity.

In one aspect, each of processor 1412 and processor 1422 may be implemented in the form of one or more single-core processors, one or more multi-core processors, or one or more CISC processors. That is, even though a singular term “a processor” is used herein to refer to processor 1412 and processor 1422, each of processor 1412 and processor 1422 may include multiple processors in some implementations and a single processor in other implementations in accordance with the present disclosure. In another aspect, each of processor 1412 and processor 1422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1412 and processor 1422 is a special-purpose machine specifically designed, arranged and configured to perform specific tasks including autonomous reliability enhancements in a device (e.g., as represented by communication apparatus 1410) and a network (e.g., as represented by network apparatus 1420) in accordance with various implementations of the present disclosure.

In some implementations, communication apparatus 1410 may also include a transceiver 1416 coupled to processor 1412 and capable of wirelessly transmitting and receiving data. In some implementations, communication apparatus 1410 may further include a memory 1414 coupled to processor 1412 and capable of being accessed by processor 1412 and storing data therein. In some implementations, network apparatus 1420 may also include a transceiver 1426 coupled to processor 1422 and capable of wirelessly transmitting and receiving data. In some implementations, network apparatus 1420 may further include a memory 1424 coupled to processor 1422 and capable of being accessed by processor 1422 and storing data therein. Accordingly, communication apparatus 1410 and network apparatus 1420 may wirelessly communicate with each other via transceiver 1416 and transceiver 1426, respectively. To aid better understanding, the following description of the operations, functionalities and capabilities of each of communication apparatus 1410 and network apparatus 1420 is provided in the context of a mobile communication environment in which communication apparatus 1410 is implemented in or as a communication apparatus or a UE and network apparatus 1420 is implemented in or as a network node of a communication network.

In some implementations, processor 1412 may perform an RL problem prediction according to an apparatus context to generate a prediction result before an RLF occurs. Processor 1412 may determine whether to perform RL early recovery based on the prediction result.

In some implementations, processor 1412 may transmit, via transceiver 1416, a measurement report to network apparatus 1420 in an event that the prediction result indicates that the RL problem will occur, and handover has possibility to be performed.

In some implementations, the handover has possibility to be performed when communication apparatus 1410 has received measurement configuration for handover, and communication apparatus 1410 is not performing handover currently, and communication apparatus 1410 has measured at least one neighboring cell that meets the predefined signal quality.

In some implementations, the measurement report includes the prediction result or not depends on if the network node supports the RL problem prediction result report or not.

In some implementations, processor 1412 may transmit, via transceiver 1416, a capability information to network apparatus 1420 to indicate whether the apparatus supports the RL problem prediction. Processor 1412 may receive, via transceiver 1416, a measurement configuration from network apparatus 1420.

In some implementations, processor 1412 may receive, via transceiver 1416, a configuration with a handover command from network apparatus 1420. Processor 1412 may switch to a target cell according to the handover command.

In some implementations, the RL problem prediction may be performed based on at least one of a rule-based algorithm, an ML algorithm, a DL algorithm and an AI algorithm.

In some implementations, the prediction result may comprise at least one of a Boolean value, one or more levels and a series of numbers.

In some implementations, the apparatus context is the context information of the apparatus within the latest time length which may comprise at least one of a cell measurement result, channel state information, power information, a control command, configured parameter information, historical camping cell information, state information of communication apparatus 1410, and a service type.

In some implementations, processor 1412 may transmit, via transceiver 1416, a reestablishment request or a connection setup request to network apparatus 1420 in an event that communication apparatus 1410 fails to receive a response for the measurement report from network apparatus 1420.

In some implementations, processor 1412 may select a candidate cell group. Processor 1412 may select at least one target cell from the candidate cell group, wherein the measurement report comprises information of the at least one target cell.

In some implementations, processor 1412 may enable a timer. Processor 1412 may determine whether a response with handover command for the measurement report is received from network apparatus 1420 before the timer is expired.

In some implementations, processor 1412 may stop the timer in an event that the response for the measurement report with handover command is received from network apparatus 1420 before the timer is expired.

In some implementations, an RL problem comprises at least one of a DL out of synchronization, an RLC retransmission fail, and an UL random access procedure fail.

In some implementations, processor 1412 may transmit, via transceiver 1416, a reestablishment request or a connection setup request to a target cell of a wireless network in an event that the prediction result indicates that the RL problem will occur, and a handover has no possibility to be performed.

In some implementations, the handover has no possibility to be performed by communication apparatus 1410 due to at least one of that a measurement configuration for handover is not configured by network apparatus 1420, communication apparatus 1410 fails to receive a handover command after transmitting a measurement report to network apparatus 1420, a DL or UL BLER is higher than a threshold which could result in communication apparatus 1410 failing to receive the handover command, or none of the measured neighboring cell meets the predefined signal quality, etc.

In some implementations, processor 1422 may receive, via transceiver 1426, a measurement report with a prediction result of an RL problem prediction from communication apparatus 1410. Processor 1422 may determine whether to respond to the measurement report based on the prediction result.

In some implementations, the prediction result is received by processor 1422, in an event that the network node supports an RL problem predication result report.

In some implementations, processor 1422 may receive, via transceiver 1426, a capability information from communication apparatus 1410, wherein the capability information indicates whether communication apparatus 1410 supports the RL problem prediction. Processor 1422 may transmit, via transceiver 1426, a measurement configuration based on the capability information to communication apparatus 1410.

In some implementations, processor 1422 may pend a handover command in an event that the prediction result indicates that the RL problem will not occur.

In some implementations, processor 1422 may transmit, via transceiver 1426, a configuration with a handover command to communication apparatus 1410 in an event that the prediction result indicates that the RL problem will occur.

In some implementations, the prediction result may comprise at least one of a Boolean value, one or more levels and a series of continue numbers.

In some implementations, processor 1422 may receive, via transceiver 1426, a reestablishment request or a connection setup request from communication apparatus 1410.

### Illustrative Processes

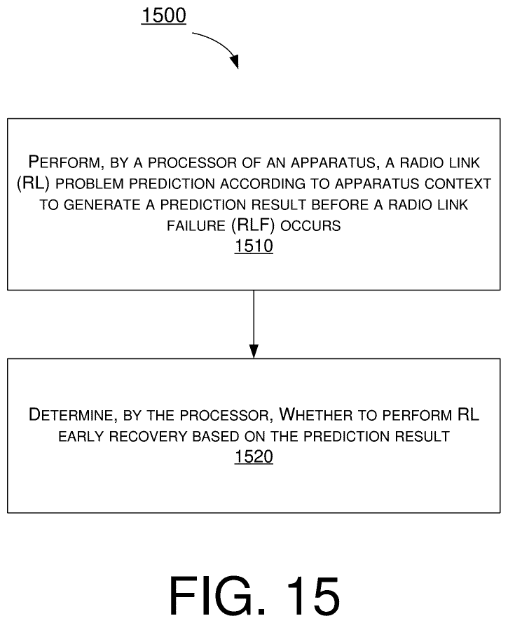

FIG. 15 illustrates an example process 1500 in accordance with an implementation of the present disclosure. Process 1500 may be an example implementation of above scenarios/schemes, whether partially or completely, with respect to RL problem prediction and early recovery with the present disclosure. Process 1500 may represent an aspect of implementation of features of communication apparatus 1410. Process 1500 may include one or more operations, actions, or functions as illustrated by one or more of blocks 1510 and 1520. Although illustrated as discrete blocks, various blocks of process 1500 may be divided into additional blocks, combined into fewer blocks, or eliminated, depending on the desired implementation. Moreover, the blocks of process 1500 may be executed in the order shown in FIG. 15 or, alternatively, in a different order. Process 1500 may be implemented by communication apparatus 1410 or any suitable UE or machine type devices. Solely for illustrative purposes and without limitation, process 1500 is described below in the context of communication apparatus 1410. Process 1500 may begin at block 1510.

At 1510, process 1500 may involve processor 1412 of communication apparatus 1410 performing an RL problem prediction according to an apparatus context to generate a prediction result before an RLF occurs. Process 1500 may proceed from 1510 to 1520.

At 1520, process 1500 may involve processor 1412 determining whether to perform RL early recovery base on the prediction result.

In some implementations, process 1500 may involve processor 1412 transmitting, via transceiver 1416, a measurement report to network apparatus 1420 in an event that the prediction result indicates that the RL problem will occur, and a handover has possibility to be performed.

In some implementations, the handover has possibility to be performed when measurement configuration for handover has been received, and handover is not being performed currently, and at least one neighboring cell that meets the predefined signal quality has been measured.

In some implementations, the measurement report includes the prediction result or not depends on if the network node supports the RL problem prediction result report or not.

In some implementations, process 1500 may involve processor 1412 transmitting, via transceiver 1416, a capability information to the network node to indicate whether the apparatus supports the RL problem prediction. Process 1500 may involve processor 1412 receiving, via transceiver 1416, a measurement configuration from the network node.

In some implementations, process 1500 may involve processor 1412 receiving, via transceiver 1416, a configuration with a handover command from the network node. Process 1500 may involve processor 1412 switching to a target cell according to the handover command.

In some implementations, process 1500 may involve processor 1412 transmitting, via transceiver 1416, a reestablishment request or a connection setup request to the network node in an event that the apparatus fails to receive a response for the measurement report from the network node.

In some implementations, process 1500 may involve processor 1412 selecting a candidate cell group. Process 1500 may involve processor 1412 selecting at least one target cell from the candidate cell group, wherein the measurement report comprises information of the at least one target cell.

In some implementations, process 1500 may involve processor 1412 enabling a timer. Process 1500 may involve processor 1412 determining whether a response with handover command for the measurement report is received from the network node before the timer is expired.

In some implementations, process 1500 may involve processor 1412 stopping the timer in an event that the response for the measurement report is received from the network node before the timer is expired.

In some implementations, process 1500 may involve processor 1412 transmitting, via transceiver 1416, a reestablishment request or a connection setup request to a target cell of a wireless network in an event that the prediction result indicates that the RL problem will occur, and a handover has no possibility to be performed.

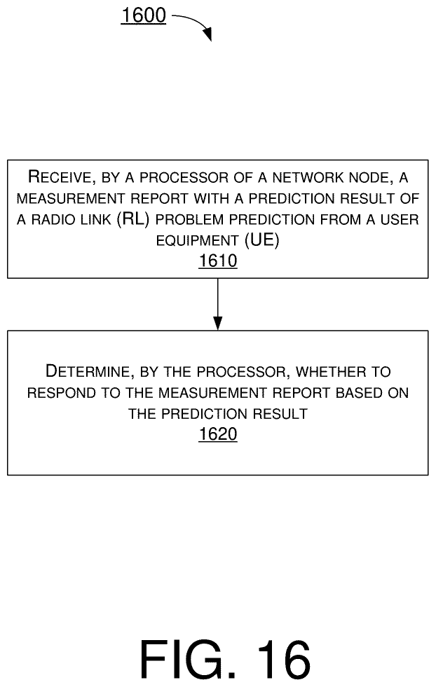

FIG. 16 illustrates an example process 1600 in accordance with another implementation of the present disclosure. Process 1600 may be an example implementation of above scenarios/schemes, whether partially or completely, with respect to RL problem prediction and early recovery with the present disclosure. Process 1600 may represent an aspect of implementation of features of network apparatus 1420. Process 1600 may include one or more operations, actions, or functions as illustrated by one or more of blocks 1610 and 1620. Although illustrated as discrete blocks, various blocks of process 1600 may be divided into additional blocks, combined into fewer blocks, or eliminated, depending on the desired implementation. Moreover, the blocks of process 1600 may be executed in the order shown in FIG. 16 or, alternatively, in a different order. Process 1600 may be implemented by network apparatus 1420 or any base stations or network nodes. Solely for illustrative purposes and without limitation, process 1600 is described below in the context of network apparatus 1420. Process 1600 may begin at block 1610.

At 1610, process 1600 may involve processor 1422 of network apparatus 1420 receiving, via transceiver 1426, a measurement report with a prediction result of an RL problem prediction from a UE. Process 1600 may proceed from 1610 to 1620.

At 1620, process 1600 may involve processor 1422 determining whether to respond to the measurement report based on the prediction result.

In some implementations, process 1600 may involve processor 1422 receiving, via transceiver 1426, a capability information from the UE, wherein the capability information indicates whether the UE supports the RL problem prediction. Process 1600 may involve processor 1422 transmitting, via transceiver 1426, a measurement configuration based on the capability information to the UE, wherein the measurement configuration configures the measurement report.

In some implementations, process 1600 may involve processor 1422 pending a handover command in an event that the prediction result indicates that the RL problem will not occur.

In some implementations, process 1600 may involve processor 1422 transmitting, via transceiver 1426, a configuration with a handover command to the UE in an event that the prediction result indicates that the RL problem will occur.

In some implementations, process 1600 may involve processor 1422 receiving, via transceiver 1426, a reestablishment request or a connection setup request from the UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, a radio link (RL) problem prediction according to an apparatus context to generate a prediction result before a radio link failure (RLF) occurs; and
determining, by the processor, whether to perform RL early recovery based on the prediction result.

2. The method of claim 1, wherein RL early recovery comprising:
transmitting, by the processor, a measurement report to a network node of a wireless network in an event that the prediction result indicates that the RL problem will occur, and a handover has possibility to be performed.

3. The method of claim 2, wherein the handover has possibility to be performed means all of these factors should be fulfilled:
the apparatus has received measurement configuration for handover,
the apparatus is not performing handover currently,
the apparatus has measured at least one neighboring cell that meets the predefined signal quality.

4. The method of claim 2, wherein the measurement report includes the prediction result or not depends on if the network node supports the RL problem prediction result report or not.

5. The method of claim 1, wherein the RL problem prediction is performed based on at least one of a rule-based algorithm, a machine learning (ML) algorithm, a deep learning (DL) algorithm and an artificial intelligence (AI) algorithm.

6. The method of claim 1, wherein the prediction result comprises at least one of a Boolean value, one or more levels and a series of numbers.

7. The method of claim 1, wherein the apparatus context is the context information of the apparatus within the latest time length which comprises at least one of a cell measurement result, channel state information, power information, a control command, configured parameter information, historical camping cell information, state information of the apparatus, and a service type.

8. The method of claim 1, wherein RL early recovery further comprising:
transmitting, by the processor, a reestablishment request or a connection setup request to the network node in an event that the apparatus fails to receive a response for the measurement report from the network node.

9. The method of claim 2, further comprising:
selecting, by the processor, a candidate cell group; and
selecting, by the processor, at least one target cell from the candidate cell group, wherein the measurement report comprises information of the at least one target cell.

10. The method of claim 1, wherein RL early recovery further comprising:
enabling, by the processor, a timer; and
determining, by the processor, whether a response with handover command for the measurement report is received from the network node before the timer is expired.

11. The method of claim 10, further comprising:
stopping, by the processor, the timer in an event that the response with handover command for the measurement report is received from the network node before the timer is expired.

12. The method of claim 1, wherein an RL problem comprises at least one of a downlink (DL) out of synchronization, a radio link control (RLC) retransmission fails, or an uplink (UL) random access procedure fail.

13. The method of claim 1, wherein RL early recovery further comprising:
transmitting, by the processor, a reestablishment request or a connection setup request to a target cell of a wireless network in an event that the prediction result indicates that the RL problem will occur, and a handover has no possibility to be performed.

14. The method of claim 13, wherein the handover has no possibility to be performed due to at least one of:
a measurement configuration for handover is not configured by a network node; or
the apparatus fails to receive a handover command after transmitting a measurement report to a network node; or
a downlink (DL) or uplink (UL) block error rate (BLER) is higher than a threshold; or
none of the measured neighboring cell meets the predefined signal quality.

15. A method, comprising:
receiving, by a processor of a network node, a measurement report with a prediction result of a radio link (RL) problem prediction from a user equipment (UE); and
determining, by the processor, whether to respond to the measurement report based on the prediction result.

16. The method of claim 15, wherein the prediction result is received in an event that the network node supports an RL problem predication result report.

17. The method of claim 15, further comprising:
receiving, by the processor, a capability information from the UE, wherein the capability information indicates whether the UE supports the RL problem prediction; and
transmitting, by the processor, a measurement configuration based on the capability information to the UE, wherein the measurement configuration configures the measurement report.

18. The method of claim 15, further comprising:
pending, by the processor, a handover command in an event that the prediction result indicates that an RL problem will not occur.

19. The method of claim 15, further comprising:
transmitting, by the processor, a configuration with a handover command to the UE in an event that the prediction result indicates that an RL problem will occur.

20. The method of claim 15, further comprising:
receiving, by the processor, a reestablishment request or a connection setup request from the UE.
